(19) United States
(12) Patent Application Publication
(10) Pub. No.: US 2021/0216977 A1
(43) Pub. Date: Jul. 15, 2021

(54) DIGITALLY ENCRYPTED ASSET TRANSFER METHOD BASED ON GOLD

(71) Applicant: ISTANBUL TAKAS VE SAKLAMA BANKASI ANONIM SIRKETI, Istanbul (TR)

(72) Inventors: Mustafa ATAHAN, Istanbul (TR); Ekrem ARIKAN, Istanbul (TR); Kerim ARICAN, Istanbul (TR); Ilker KUSCU, Istanbul (TR); Mustafa SENTURK, Istanbul (TR)

(21) Appl. No.: 16/634,288

(22) PCT Filed: Sep. 19, 2018
(86) PCT No.: PCT/TR2018/050507

§ 371 Date: Jan. 27, 2020

(51) Int. Cl. G06Q 20/06; G06Q 20/38; G06Q 20/02; G06Q 20/36; G06Q 20/40

(52) U.S. Cl. CPC G06Q 20/06; G06Q 20/38215; G06Q 2220/00; G06Q 20/363; G06Q 20/4014; G06Q 20/02

(57) ABSTRACT

A method of providing a payment system based on the unallocated gold transfer and digitally encrypted gold transfer between parties.

### TECHNICAL DESCRIPTION

The invention relates to a method of transferring digitally encrypted assets based on gold within the blockchain approach.

In particular, the invention relates to a method of providing a gold based payment system with the unallocated gold transfer and digital gold transfer between the different entities.

### PRIOR ART

Today, examples of asset transfer solutions that work with the logic of blockchain are becoming widespread.

The current technique is based on Dubai-based digital money, One Gram Coin and London-based Goldmint digital products. When these two solutions are examined, they do not guarantee that they are kept behind 100% physical gold. In addition, in the two solutions developed by using the blockchain approach, it is not explicit what information and the persons and/or institutions that confirm this information are. At the same time, all stakeholders, who store and approve the data, can clearly see all the transaction amounts and the transfer makers. This is due to the inability to provide the cryptological proof in the blockchain approaches in these solutions. Since these products are traded on crypto money exchanges, their values are changing instantly, so there is no valuation indexed to gold's market value. Furthermore, there is no information regarding the regulatory requirements and addressing the need for public authority.

As a result, the problems that cannot be solved in the light of the aforementioned and the present techniques necessitated an innovation in the relevant technical field.

### BRIEF DESCRIPTION OF THE INVENTION

The present invention relates to the development of a method of digitally encrypted asset transfer based on the gold to eliminate the aforementioned disadvantages and to bring new advantages to the technical field concerned.

The main objective of the invention is to provide a method of generating a payment system based on gold by unallocatedly and digitally transferring gold between the entities. By means of this payment system infrastructure, different assets (silver, bronze, etc.) can be transferred by the method within the scope of the present invention.

Another objective of the invention is to establish a structure in which the value of the assets in the digital environment is kept 100% physically.

Another objective of the invention is to develop a method that pricing the value of the generated digitally encrypted asset according to the market value of the valuable asset to which it is physically connected, and hence is closed to speculation.

Another objective of the invention is to develop a method which meets the needs of the cryptological proof and monitoring of the authority which is expected to be solved in the current blockchain world (which is addressed in FIG. 2).

Another objective of the invention is to develop a method by generating relevant cryptological proof algorithms to meet the requirements of the regulations, to which the competent authority can view the records, to see only the transaction information of the parties performing the transaction, and to display and verify the transactions only with the other stakeholders holding and registering the record.

In order to realize all the foregoing and all other objects that arise from the following detailed description, the present invention is a method of transferring the gold unallocatedly and digitally between the parties by means of gold based digital payment method. According to this method;
Literature review,
Formation of a gold transfer system that enables the transfer of gold between the institutions and/or persons' accounts by unallocated the gold that is physically kept in safes,
Creation of a digitally encrypted asset platform based on gold,
Integration of the existing gold transfer system and the digitally encrypted asset platform based on gold,
Determination of the consensus algorithm that controls the provision of sufficient criteria for the accuracy of any transaction,
Determining the characteristics of the nodes in which transactions are stored and approved on blockchain,
Designing the wallet and digital identity architecture,
Establishing such procedures in such a way as to allow the regulations to be validated by means of methods specified in the literature known as zero knowledge proof in order to confirm the data without any data displayed to endorser (who confirms the transaction),
Designing the content of the transactions in regard to regulations,
Integrating all system assets together,
   steps are included.

In order to thoroughly understand the advantages of the present invention in conjunction with its embodiment, it should be considered together with the figures described below.

### BRIEF DESCRIPTION OF THE DRAWINGS

FIG. 1 shows a schematic view of an exemplary system using the method.

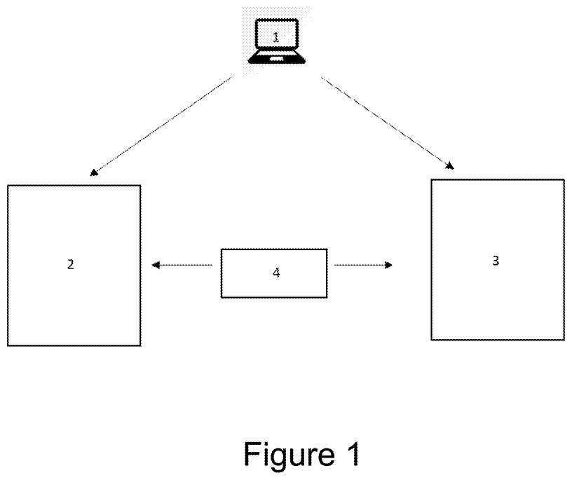

FIG. 2 shows the content of a transaction.

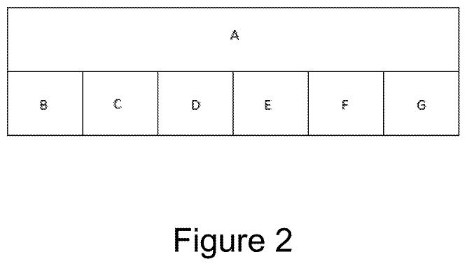

FIG. 3 illustrates a flow chart of the method of the invention.

### REFERENCE NUMBERS

1. End users

2. Gold Transfer System

3. Digital Gold Asset Platform

4. BIGA digitally encrypted asset

1001. Literature review.

1002. Formation of a gold transfer system that enables the transfer of gold between the institutions and/or persons' accounts by unallocated the gold that is physically kept in safes.

1003. Creation of a digitally encrypted asset platform based on gold.

1004. Integration of the existing gold transfer system and the digitally encrypted asset platform based on gold.

1005. Determination of the consensus algorithm that controls the provision of sufficient criteria for the accuracy of any transaction.

1006. Determining the characteristics of the nodes in which transactions are stored and approved on blockchain.

1007. Designing the wallet and digital identity architecture.

1008. Establishing such procedures in such a way as to allow the regulations to be validated by means of methods specified in the literature known as zero knowledge proof in order to confirm the data without any data displayed to endorser (who confirms the transaction).

1009. Designing the content of the transactions in regard to regulations.

1010. Integrating all system assets together.

A. Signature of the trader

B. Pub (V) customer 1

C. Pub (V) customer 2

D. Pub (V) authority institution

E. Equality Proof

F. Equality Proof 2

G. Range proof

### DETAILED DESCRIPTION OF THE INVENTION

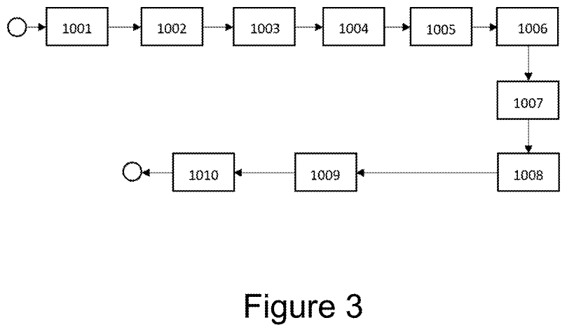

In this detailed description, the novelty of the invention is explained by examples which will not have any limiting effect on a better understanding of the subject. FIG. 3 shows a schematic flow diagram of the method of our invention. Our invention is a gold-based digitally encrypted asset transfer method that enables the transfer of gold between parties unallocatedly and digitally thus forming a payment system based on gold. According to this method; literature review (1001), the creation(1002) of the gold transfer system (2), formation of a gold transfer system that enables the transfer of gold between the institutions and/or persons' accounts by unallocated the gold that is physically kept in safes, integration(1004) of the gold transfer system (2) and the digitally encrypted asset platform (3) based on the gold(1003), determining the consensus algorithm (1005), which controls the provision of sufficient criteria for the accuracy of any transaction, according to the needs of the properties of the nodes where the block chain based operations are (1006), the design of the wallet and the digital identity structure (1007) can be created in such a way as to enable the regulation of the zero evidence of information, which allows the validation of the transactions without any data displayed on the specified properties. (1008), the process of designing the content of the transactions to be made in accordance with the regulation (1009), including the integration of all system assets (1010).

In the preferred embodiment of our invention, the literature review (1001) includes the processing step, the infrastructure of the existing products using block-breaking technology and technology, and/or review of articles, reports, news, videos, training materials and/or national and international workshops, and/or reviewing the use of open source codes and/or reviewing the use-case reports and open source codes.

Establishment of the gold transfer system (2) which enables the transfer of gold between the accounts of the institutions and/or persons to be physically stored in safes (1002) and the physical delivery of the gold to the safes and the gold transfer system (2) by the Bank. The gold transfer system (2) application of the gold formed by the bank's gold transfer system (2) and the customer's gold transfer system (2) to ensure the physical output of the recorded balance is realized.

The creation of the gold based digitally encrypted asset platform (3) (1003) in the processing step; The digital value generated by advanced mathematical formulas (sha256, sha3, etc.), expressed as a gram of gold coins, crypto token, ensures the reconciliation of the produced digital value with the physical gold equivalents. The reliability of the transfer of the value between the relevant identified stakeholders is ensured by the advanced mathematical formulas. Thanks to the blockchain approach, all data and formulas can be securely stored in the relevant defined stakeholders, and the relevant identified stakeholders can access these data with advanced mathematical formulas within their competencies and limits.

At the step of integration of the gold transfer system (2) and the digitally encrypted asset platform (3) based on the gold (1004), BiGA digitally encrypted assets (4), which are generated on 1 gram of gold the corresponding to 1 BiGA, and the BiGA digitally encrypted assets (4) are created on the bank's digitally encrypted asset platform (3) on the demand of customer. The platform provides to convert 1 gram gold to digitally encrypted assets and vice versa.

The consensus algorithm (1005) which controls the provision of sufficient criteria for the validity of any transaction is determined by assessing the confidentiality, integrity and availability risks. In this process step one of the existing consensus algorithms in blockchain technology can be used or a new consensus algorithm can be created within the system requirements.

Determining the properties of the nodes in which the blockchain based operations are stored and approved according to the need (1006) in the processing step. Nodes are included in the consensus process by the system provider as validators to ensure the accuracy and integrity of the data. Nodes that do not have validating right only store the data and thus have no consensus effects.

In the process step of designing the wallet and digital identity structure (1007), customers are able to store and transfer BiGA digitally encrypted assets (4). The aim is to prevent uncertainty about the identity of the person making the transactions by approving the real owner of account with the blockchain technology.

Designing the content of the transactions to be regulated in accordance with the regulation (1009); the gold value to be transferred is encrypted by the sender, the pub (V) customer 1 (B) (the sender's public key) and pub (V) customer 2 (C) (receiver's public key). This value is also encrypted with the pub (V) authority institution (D) (authority's public key) so that it can be monitored by the authority. The contents of the values encrypted with these three different public keys cannot be read by other participants in the non-processing network. However, it is necessary to check that this encrypted values are equal. In this context, equality proof (E), which is the proof that the value encrypted with the pub (V) client 1 (B) (the sender's public key) is equal to the value encrypted with the pub (V) customer 2 (C) (the public key of the receiver). In this way, the amount from the sender account is shown to be equal to the amount of the buyer's account. In addition, this value is encrypted with the public key of the authority is the same as the data that is proved to be the equal is also required by equality proof-2 (F). Thus, the amount of transfer made and transfer amount observed by the authority are ensured to be equal. Finally, a range proof (G) is made so that the sender cannot spend more than the current balance. All this evidence is made and encrypted data (pub (V) customer 1 (B), pub (V) customer 2 (C), pub (V) authority institution (D), equality proof (E), equality proof-2 (F), the range proof (G)) is passed through a hash function and signed with the signature (A) of the sender which is the private key of the sender. As a result of all these transactions, transfer of value on the blockchain network, keeping the content of the transaction confidential, being able to be approved by all participants even if the content is not known, and being followed by the authority when necessary.

In the step of integrating all system assets (1010), the gold transfer system (2), the digital platform based on the gold (3), the wallet, the nodes included in the system and the digital identity applications are integrated and all these elements work synchronously.

As a result of the method according to our invention, a gold transfer system (2) will be provided where the gold based digitally encrypted asset platform (3) and its transfer based on the blockchain technology will be realized. The blockchain approach to be used within the scope of the project can be explained as a system using a distributed database that provides encrypted transaction tracking. With the establishment of the Gold Transfer System (2), the end users (1) who are willing to transfer the gold will be able to transfer gold with their registered gold. End users (1) who have gold in the gold transfer system (2) will be able to purchase BiGA digitally encrypted assets (4), which are exported via the digitally encrypted asset platform (3), if they wish. They will be able to do peer to peer transfer on this system. These blockchain-based operations will be stored and approved by the nodes. In addition, zero knowledge proof of the work with the information in this distributed database is only known by the sender, the receiver and authority institution, but all nodes validating the transaction details will see nothing. Although our invention will work based on the gold in the first phase, it can be used in time for any value attributed to it with its parametric infrastructure.

1. A method of transferring gold between parties by unallocatedly and digitally, is a method of transferring a gold-based payment system comprising the following steps:
literature review;
formation of a gold transfer system that enables the transfer of gold between institutions and/or persons' accounts by unallocated the gold that is physically kept in safes;
creation of a digitally encrypted asset platform based on gold;
integration of the existing gold transfer system and the digitally encrypted asset platform based on gold;
determination of a consensus algorithm that controls the provision of sufficient criteria for the accuracy of any transaction;
determining characteristics of nodes in which transactions are stored and approved on blockchain;
designing a wallet and digital identity architecture;
establishing such procedures in such a way as to allow regulations to be validated by means of methods specified in the literature known as zero knowledge proof in order to confirm the data without any data displayed to endorser (who confirms the transaction);
designing the content of the transactions in regard to regulations; and
integrating all system assets together.
